(19) United States
(12) Patent Application Publication
(10) Pub. No.: US 2010/0136407 A1
(43) Pub. Date: Jun. 3, 2010

(54) Battery cell with a partial dielectric barrier for improved battery pack mechanical and thermal performance

(75) Inventors: William Vucich Beecher, San Francisco, CA (US); Weston Arthur Hermann, Palo Alto, CA (US); Paul Bryan Kreiner, Palo Alto, CA (US); Ernest Matthew Villanueva, San Mateo, CA (US); Kurt Russell Kelty, Palo Alto, CA (US)

Correspondence Address: PATENT LAW OFFICE OF DAVID G. BECK, P. O. BOX 1146, MILL VALLEY, CA, 94942, US

(73) Assignee: Tesla Motors, Inc., San Carlos, CA (US)

(21) Appl. No.: 12/381,821

(22) Filed: Mar. 17, 2009

Related U.S. Application Data
(60) Provisional application No. 61/206,586, filed on Jan. 31, 2009.

(51) Int. Cl. H01M 2/26

(52) U.S. Cl. 429/121

(57) ABSTRACT

The adverse effects of the dielectric material covering the lateral outer surface of a conventional battery are eliminated by replacing it with a dielectric barrier that covers less than 20 percent of the lateral outer surface of the cell case; more preferably less than 15 percent of the lateral outer surface of the cell case; still more preferably less than 10 percent of the lateral outer surface of the cell case; and yet still more preferably less than 5 percent of the lateral outer surface of the cell case. The dielectric barrier may be shrunk-fit, bonded, friction-fit or otherwise held in place. An electrically insulating disk may be interposed between the dielectric barrier and the end edge portion of the cell case.

### CROSS-REFERENCE TO RELATED APPLICATION

This application claims the benefit of the filing date of U.S. Provisional Patent Application Ser. No. 61/206,586, filed Jan. 31, 2009, the disclosure of which is incorporated herein by reference for any and all purposes.

### FIELD OF THE INVENTION

The present invention relates generally to battery cells and, more particularly, to a method and apparatus for improving the mechanical and thermal performance of the individual battery cells that are integrated within a battery pack.

### BACKGROUND OF THE INVENTION

Battery packs, also referred to as battery modules, have been used for years in a variety of industries and technologies that include everything from portable electric tools and laptop computers to small hand-held electronic devices such as cell phones, MP3 players, and GPS units. In general, a battery pack is comprised of multiple individual batteries, also referred to as cells, contained within a single or multi-piece housing. Single piece housings are often comprised of shrink-wrap while multi-piece housings often rely on a pair of complementary housing members that are designed to fit tightly around the cells when the housing members are snapped or otherwise held together. Typically a conventional battery pack will also include means to interconnect the individual cells as well as circuitry to enable charging and/or to protect against overcharging.

Recent advances in the development of hybrid and electric vehicles have lead to the need for a new type of battery pack, one capable of housing tens to hundreds to even thousands of individual cells. For example, the battery pack used in at least one version of the Roadster manufactured by Tesla Motors contains nearly 7000 individual Li-ion cells, the individual cells having the 18650 form-factor. In addition to requiring this new type of battery pack to house a large number of cells, it must be capable of surviving the inherent thermal and mechanical stresses of a car for a period of years while minimizing weight, as hybrids and electric cars are exceptionally sensitive to excess weight. Lastly, the design of a vehicle battery pack should lend itself to efficient, and preferably automated, manufacturing practices.

The fundamental building block of a battery pack is the individual cell. As such, each cell will preferably meet certain criteria, thereby enabling the fabrication of an efficient and reliable battery pack. First, the cell's design must lend itself to efficient thermal dissipation as each cell within the battery pack can generate significant heat during use and/or charging. Second, it must be capable of being securely mounted within the battery pack as movement of the individual cells within the battery pack can lead to shorting, cell damage, contact breakage, or other failure. Third, each cell should include some form of electrical insulation to minimize the risk of shorting during handling, installation and use. The present invention provides an improved cell design that achieves each of these goals.

### SUMMARY OF THE INVENTION

The present invention eliminates the adverse effects of the dielectric material covering the lateral outer surface of a conventional battery by eliminating this covering and replacing it with a dielectric barrier that covers less than 20 percent of the lateral outer surface of the cell case; more preferably less than 15 percent of the lateral outer surface of the cell case; still more preferably less than 10 percent of the lateral outer surface of the cell case; and yet still more preferably less than 5 percent of the lateral outer surface of the cell case. The dielectric barrier may be comprised of a shrink-fit material or molded, exemplary materials including synthetic polymers, synthetic fluoropolymers and polyimides. The dielectric barrier may be shrunk-fit, bonded, friction-fit or otherwise held in place. An electrically insulating disk may be interposed between an inner surface of the dielectric barrier and an outer surface of the end edge portion of the cell case. The dielectric barrier of the invention is configured to provide access to the battery terminal while preventing shorting between the terminal and the edge of the cell casing, thereby significantly improving cell heat transfer efficiency while providing a better surface, i.e., the bare cell casing, to which to bond, clamp, or otherwise attach to during cell integration within a battery pack or other package.

A further understanding of the nature and advantages of the present invention may be realized by reference to the remaining portions of the specification and the drawings.

### BRIEF DESCRIPTION OF THE DRAWINGS

FIG. 1 is a simplified cross-sectional illustration of a cell utilizing the 18650 form-factor;

FIG. 2 illustrates the conventional dielectric covering applied to the cell shown in FIG. 1;

FIG. 3 illustrates a minor modification of the dielectric covering shown in FIG. 2;

FIG. 4 illustrates a dielectric barrier in accordance with a preferred embodiment of the invention;

FIG. 5 illustrates an end-view of the dielectric barrier shown in FIG. 4;

FIG. 6 illustrates a dielectric barrier similar to that shown in FIG. 4;

FIG. 7 illustrates a dielectric barrier similar to that shown in FIG. 4, with the addition of an interposed insulating disk;

FIG. 8 illustrates a molded dielectric barrier in accordance with a preferred embodiment of the invention; and

FIG. 9 illustrates a molded dielectric barrier similar to that shown in FIG. 8, with the addition of an interposed insulating disk.

### DESCRIPTION OF THE SPECIFIC EMBODIMENTS

In the following text, the terms “battery”, “cell”, and “battery cell” may be used interchangeably and may refer to any of a variety of different rechargeable cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration. The term “battery pack” as used herein refers to multiple individual batteries contained within a single piece or multi-piece housing, the individual batteries electrically interconnected to achieve the desired voltage and capacity for a particular application. It should be understood that identical element symbols used on multiple figures refer to the same component, or components of equal functionality. Additionally, the accompanying figures are only meant to illustrate, not limit, the scope of the invention and should not be considered to be to scale.

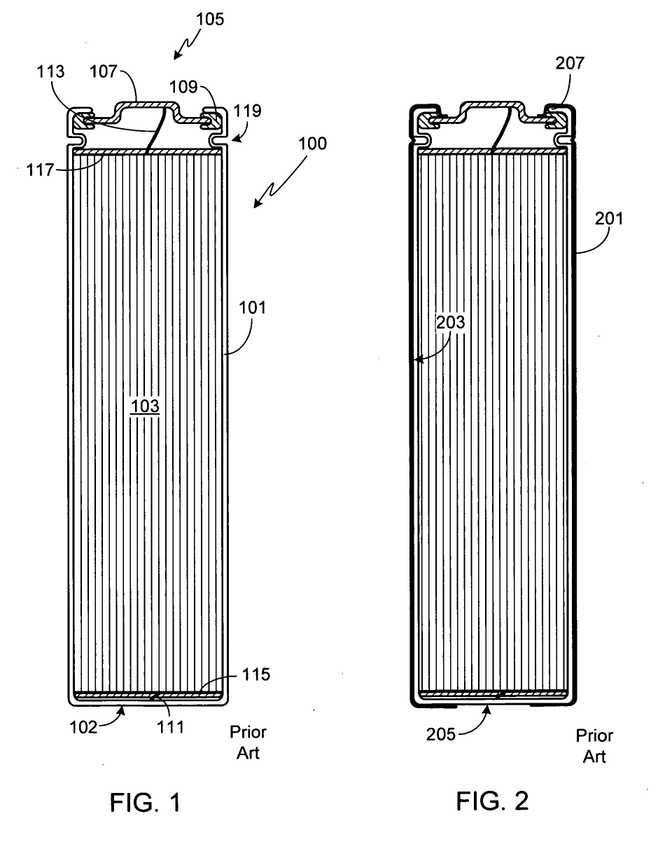

FIG. 1 is a simplified cross-sectional view of a battery 100, for example a lithium ion battery, utilizing the 18650 form-factor. Battery 100 includes a cylindrical case 101, an electrode assembly 103, and a cap assembly 105. Case 101 is typically made of a metal, such as nickel-plated steel, that has been selected such that it will not react with the battery materials, e.g., the electrolyte, electrode assembly, etc. For an 18650 cell, case 101 is often referred to as a can as it is comprised of a cylinder and an integrated, i.e., seamless, bottom surface 102. Cap assembly 105 includes a battery terminal 107, e.g., the positive terminal, and an insulator 109, insulator 109 preventing terminal 107 from making electrical contact with case 101. Cap assembly 105 typically also includes an internal positive temperature coefficient (PTC) current limiting device and a venting mechanism (neither shown), the venting mechanism designed to rupture at high pressures and provide a pathway for cell contents to escape. Cap assembly 105 may contain other seals and elements depending upon the selected design/configuration. Electrode assembly 103 is comprised of an anode sheet, a cathode sheet and an interposed separator, wound together in a spiral pattern often referred to as a ‘jelly-roll’. An anode electrode tab 111 connects the anode electrode of the wound electrode assembly to the negative terminal while a cathode tab 113 connects the cathode electrode of the wound electrode assembly to the positive terminal. In the illustrated embodiment, the negative terminal is case 101 and the positive terminal is terminal 107. In most configurations, battery 100 also includes a pair of insulators 115/117. Case 101 includes a crimped portion 119 that is designed to help hold the internal elements, e.g., seals, electrode assembly, etc., in place.

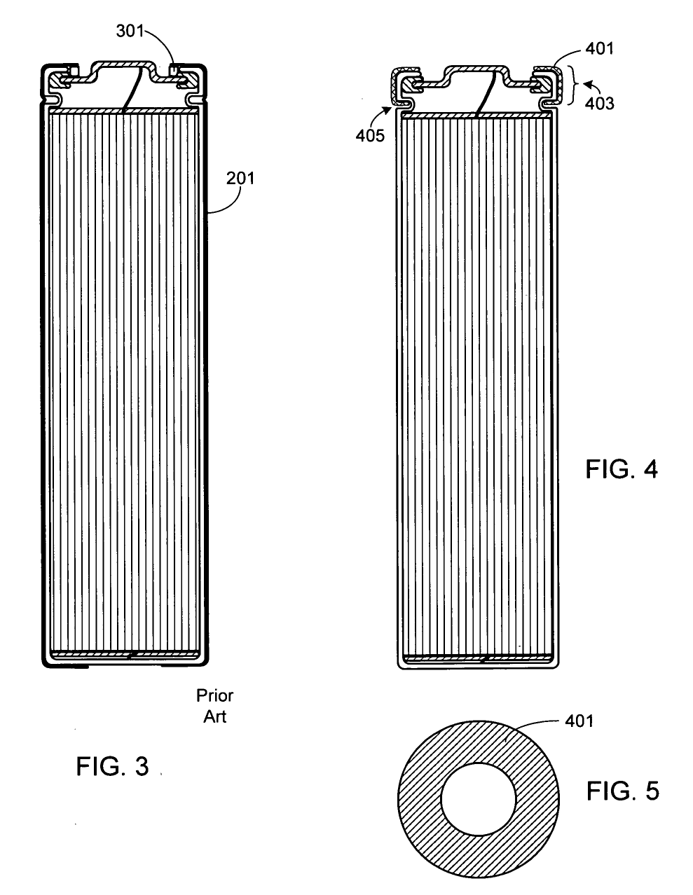

In a typical cell fabrication process, the last step is to surround case 101 with a dielectric material 201, as shown in FIG. 2. More specifically, material 201 covers the entire cylindrical lateral surface 203, a portion of bottom surface 205, and a portion of the cap assembly 105. In a conventional cell, dielectric material 201 is comprised of a shrink-wrap material, thus allowing a snug fit to be achieved and one in which it is unlikely that the material will slip out of place. The primary purpose of outer case covering 201 is to decrease the chances of inadvertently shorting the cell during normal handling and use, a possibility that is enhanced by the entire case 101 being connected to the anode and the proximity of positive terminal 107 to the edge portion 207 of case 101. Some battery manufacturers even add an additional layer 301 of insulating material between the battery casing and outer covering 201 as shown in FIG. 3, layer 301 helping to insure that edge portion 207 of case 101 is covered. Note that in a conventional cell, edge portion 207 is bent over as shown, at an approximately 90 degree angle from the cylindrical lateral wall of case 101, thereby holding cap assembly 105 in place.

Although the prior approach to covering case 101 serves its intended purpose, i.e., minimizing the risk of inadvertent shorting, the present inventors have found that such an approach has significant drawbacks relative to the fabrication of, and use within, large battery packs as required by certain applications, e.g., electric vehicles. The four primary areas adversely affected by dielectric covering 201 are efficient heat transfer, mechanical robustness, overall system energy efficiency, and cell tolerances.

Heat transfer—Battery cells, especially those utilizing advanced cell chemistries to achieve higher energy densities such as lithium ion and lithium ion polymer, generate significant heat during operation. Excessive heat not only leads to reduced battery life and performance, it can also pose a significant fire hazard. The problems associated with excessive heat generation are clearly exacerbated in large battery packs that may house hundreds or thousands of cells in close proximity to one another. To overcome the problems associated with excessive heat generation, it is imperative that this heat be efficiently removed from the battery pack, and thus the individual cells. Unfortunately, while dielectric cover 201 provides a safeguard against inadvertent shorting, its poor thermal conductivity significantly impacts the efficient removal of generated heat.

Mechanical robustness—In a large battery pack, i.e., one containing hundreds to thousands of cells, and especially in a battery pack contained within a vehicle where it is routinely subjected to vibrations and erratic shaking, it is critical that each cell remain in place, thus minimizing the risk of damage to the cells, cell interconnects, cooling conduits, mounting structures and associated battery electronics contained within the battery pack. The design of a conventional cell, however, does not lend itself to such an approach since in a conventional cell, the outer dielectric covering 201 is not bonded to the cell casing, rather it is simply shrink-wrapped into place. As such, bonding a conventional cell into a battery pack will lead to an insecure, and therefore inadequate, mechanical connection between the underlying cell casing and the rest of the battery pack.

Mass—In a conventional cell, the dielectric cover material 201 can have a mass of approximately a gram. Although this quantity is relatively inconsequential when viewed by itself, when multiplied by the thousands of cells contained within a large battery pack, this mass becomes significant.

Cell Tolerance—The thickness of dielectric cover material 201 can vary considerably, resulting in similar variations in the dimensions of a conventional cell to which it is applied. This, in turn, makes it difficult to maintain the tight tolerances desired in order to achieve tight packing density, efficient heat withdrawal and automated manufacturing processes.

To overcome the deficiencies of a conventional battery, the present invention eliminates dielectric material 201, leaving the majority of the lateral outer surface, e.g., surface 203, and the entire bottom surface, e.g., surface 205, bare and uncovered. According to a preferred embodiment of the invention, dielectric material 201 is replaced with a small dielectric barrier, also referred to herein as a cell cap, the dielectric barrier surrounding terminal 107 as illustrated in the following figures.

FIG. 4 illustrates an embodiment of the invention applied to an 18650 cell, although it will be appreciated that the same approach may be used on other cell configurations. As shown in FIG. 4, dielectric barrier 401 covers the top edge portion of casing 101 and extends down and surrounds a small length 403 of outer cylindrical surface 203. FIG. 5 shows a top view of dielectric barrier 401. Although dielectric barrier 401 may be fabricated from any material providing low electrical conductivity, preferably it is fabricated from a shrink-wrap material, thus simplifying application to the body of the cell. Exemplary shrink-wrap materials include a variety of polymers, such as polyalkene. If the cell case includes a crimped portion such as portion 119 in 18650 cell 100, preferably the dielectric material extends at least part way into the crimp as shown at region 405, thereby helping to hold the barrier in place. More preferably the dielectric material extends part way into the crimp, but does not extend further down the side of the case, for example as shown in FIGS. 4, 6 and 7.

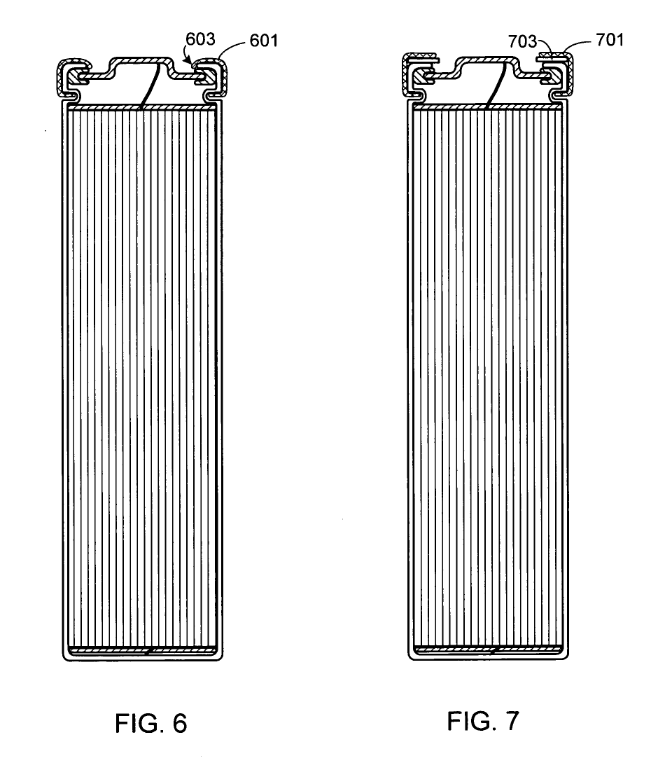

FIG. 6 illustrates a minor modification of dielectric barrier 401 that is intended to further reduce the risk of inadvertent shorting between case edge 207 and terminal 107. Specifically, dielectric barrier 601 has a smaller diameter opening surrounding terminal 107 than the previous embodiment, thereby causing a portion 603 of barrier 601 to completely cover edge portion 207 as shown. As in the prior embodiment, preferably barrier 601 is fabricated from a shrink-wrap material in order to simplify cell fabrication.

FIG. 7 illustrates another embodiment of the invention using a shrink-wrap barrier 701 that is similar to barrier 401. In this embodiment, however, an electrically insulating disk 703 is interposed between the outer surface of case edge 207 and the inner surface of cap 701 as shown, thus further reducing the risk of shorting. Disk 703 may be fabricated from any material providing low electrical conductivity, exemplary materials including synthetic polymers (e.g., nylon), synthetic fluoropolymers (e.g., Teflon), and polyimides (e.g., Kapton). Preferably disk 703 is bonded to the outer surface of edge portion 207, thus insuring that it remain in place during the placement and shrinking of barrier 701.

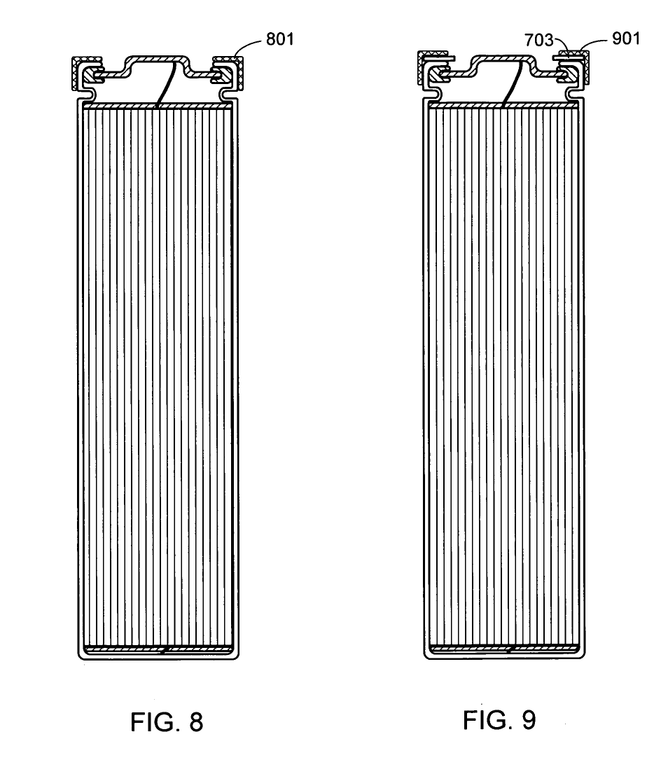

In an alternate embodiment of the invention, the barrier is molded rather than being comprised of a shrink-wrap material, thereby providing greater flexibility in barrier material selection. FIG. 8 illustrates a molded cap 801 while FIG. 9 illustrates a similarly-designed molded cap 901 with an electrically insulating disk 703 interposed between the inner cap surface and the outer surface of case edge 207. Molded caps 801 and 901 may either be bonded in place, or held in place using a friction fit. In the latter approach, preferably the cap is fabricated from an elastomeric material. In general, caps 801 and 901 as well as disk 703 may be fabricated from any material having a low electrical conductivity, exemplary materials including synthetic polymers (e.g., nylon, elastomers such as rubber, etc.), synthetic fluoropolymers (e.g., Teflon), and polyimides (e.g., Kapton).

For each of the previously described embodiments of the invention, preferably the dielectric barrier covers substantially less than 50 percent of the lateral surface area of the cell, e.g., surface 203 of cell 100, more preferably no more than 20 percent of the lateral surface area, still more preferably no more than 15 percent of the lateral surface area, yet still more preferably no more than 10 percent of the lateral surface area, and yet still more preferably no more than 5 percent of the lateral surface area. In addition to being a dielectric, preferably the material used for the barrier as well as for the disk in the embodiments illustrated in FIGS. 7 and 9 has a relatively high melting temperature, at least sufficient to withstand the expected temperature extremes that correspond to the cell on which the barrier is to be used.

Although the barriers disclosed and described herein prevent common shorting problems, they are small enough to have very little impact on heat transfer out of the cell. For example, in a conventional cell utilizing the 18650 form-factor, dielectric material covers approximately 94 percent of the cell's total surface area, i.e., all of the lateral surface area and a portion of the top and bottom surfaces. In contrast, the dielectric barriers of the present invention cover between approximately 5 and 20 percent of the cell's total surface area, depending upon how far the barrier extends down the lateral cell surface. Accordingly, by replacing dielectric cover 201 with a dielectric barrier in accordance with the invention, between 74 and 89 percent less cell surface is covered. This leads to significant improvements in heat transfer efficiency that, in turn, provide improved cell and battery pack performance while reducing the risks associated with cell overheating.

In addition to significantly improving heat transfer efficiency, the present invention also dramatically improves battery mounting within the pack. Specifically, removal of the dielectric material 201 from the cell allows the cell mounting means, for example an adhesive bond, to be applied directly to the cell casing. As a result, a much more robust and secure mechanical connection is formed between the cell and the battery pack, leading to a more reliable battery pack even when subjected to the vibration-intense environment of a car.

Lastly, replacement of material cover 201 with a partial dielectric barrier can significantly reduce the weight of the battery pack. For example, assuming a mere reduction of 1 gram per cell, in a 7,000 cell battery pack, a weight savings of 7 kilograms is achieved.

Although the preferred embodiment of the invention is utilized with a cell using the 18650 form-factor, it will be appreciated that the invention can be used with other cell designs, shapes and configurations.

As will be understood by those familiar with the art, the present invention may be embodied in other specific forms without departing from the spirit or essential characteristics thereof.

What is claimed is:

1. A battery, comprising:
a cell case having a lateral outer surface, a first end and a second end, wherein said first end is closed by a cell case bottom, and wherein said second end is comprised of a central open portion;
an electrode assembly contained within said cell case, wherein a first electrode of said electrode assembly is electrically connected to said cell case;
a cap assembly mounted to said cell case, said cap assembly closing said central open portion of said second end, wherein said cap assembly further comprises a battery terminal electrically isolated from said cell case and electrically connected to a second electrode of said electrode assembly; and
a dielectric barrier surrounding an end portion of said cell case proximate to said second end and said cap assembly, said dielectric barrier covering 20 percent or less of said lateral outer surface of said cell case.

2. The battery of claim 1, wherein said battery has an 18650 form-factor, wherein said lateral outer surface is cylindrical, and wherein said cell case bottom is integral to said cell case.

3. The battery of claim 1, wherein said dielectric barrier covers 15 percent or less of said lateral outer surface of said cell case.

4. The battery of claim 1, wherein said dielectric barrier covers 10 percent or less of said lateral outer surface of said cell case.

5. The battery of claim 1, wherein said dielectric barrier covers 5 percent or less of said lateral outer surface of said cell case.

6. The battery of claim 1, wherein said dielectric barrier is comprised of a shrink-fit material, and wherein said dielectric barrier is shrunk to fit said lateral outer surface of said cell case.

7. The battery of claim 1, further comprising an electrically insulating disk interposed between an inner surface of said dielectric barrier and an outer surface of an end edge portion of said cell case.

8. The battery of claim 7, wherein said electrically insulating disk is comprised of a material selected from the group of materials consisting of synthetic polymers, synthetic fluoropolymers, and polyimides.

9. The battery of claim 1, wherein said dielectric barrier is comprised of a material selected from the group of materials consisting of synthetic polymers, synthetic fluoropolymers, and polyimides.

10. The battery of claim 1, wherein said dielectric barrier is comprised of a molded end cap.

11. The battery of claim 10, wherein said molded end cap is comprised of an elastomeric material.

12. The battery of claim 1, wherein said dielectric barrier is friction fit to said cell case.

13. The battery of claim 1, wherein said dielectric barrier is bonded to said cell case.

14. The battery of claim 1, wherein a portion of said dielectric barrier extends into a crimped region on said lateral outer surface of said cell case.

15. The battery of claim 14, wherein said dielectric barrier does not extend beyond said crimped region on said lateral outer surface of said cell case.
